(19) United States
(12) Patent Application Publication
(10) Pub. No.: US 2005/0049888 A1
(43) Pub. Date: Mar. 3, 2005

(54) Event memorabilia holder and methods

(76) Inventors: James Eisenberg, Newport Beach, CA (US); Robert J. Weber, Santa Ana, CA (US); Don E. N. Gibson, Los Angeles, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/652,825

(22) Filed: Aug. 28, 2003

(51) Int. Cl. G06F 17/60

(52) U.S. Cl. 705/1

(57) ABSTRACT

A memento is created at a concession on location at a ballgame, concert or other event. In general, the memento is created by receiving an event-related item from an attendee, encapsulating it, and returning the encapsulated item to the attendee. Almost any item can serve as an event-related item, including entrance ticket or ticket stub, or program, or even a cocktail napkin or drink swirler. The value of the encapsulated item can be enhanced by including in the container an identifier card, label, pin, logo, special graphics, or other indicia that is available only (or mostly) at the event due to contractual prohibitions on availability elsewhere. Preferred methods of encapsulating include using a monolithic solid piece of plastic that completely envelopes the memento, or a using a jewel case in which the memento is contained in a compartment.

### FIELD OF THE INVENTION

The field of the invention is protection of event-related items.

### BACKGROUND

People attending a sporting or other event often desire to commemorate their attendance by keeping a ticket, ticket stub, or other event-related item as a memento. Unfortunately, such mementos can easily be lost or damaged during or after the event.

There already various means of protecting tickets. For example, at professional or other conferences it is very common to protect a ticket or attendance stub by slipping it into a thin plastic holder. Such holders typically have a pin or clip that fastens the holder to a shirt or other article of clothing, and in some instances holders are designed to hang from a lanyard worn around the neck.

One drawback to the known holders is that they are not especially attractive, and do little or nothing to enhance the value of the ticket or stub. There are services that will encapsulate a ticket or any other small memorabilia in an attractive plexiglass slab. Authentic slabbed Superbowl tickets, for example, are available as collectors items on the Internet. Indeed, there are several mail in services for slabbing all sorts of memorabilia

What has not been appreciated is that ticket holders and other attendees or ballgames, concerts or other events might prefer to having their memorabilia encapsulated at the event, rather than days or weeks later. Among other things it was not appreciated how that need could be satisfied in a commercially beneficial manner.

### SUMMARY OF THE INVENTION

The present invention is directed to the creation of a memento at a concession on location at a ballgame, concert or other event. In general, the memento is created by receiving an event-related item from an attendee, encapsulating it, and returning the encapsulated item to the attendee.

The term “concession” is used here in its ordinary meaning, which generally includes a subsidiary business located at the event, which is authorized by the ballpark, concert call or other venue of the event, or the promoters or owners of the event. The concession may have its own booth or “stand”, or it may provide services out of another concession such as a memorabilia store. A given event may have one or more locations that provide services of the concession. The term “concession” is contemplated herein to be distinct from mere sponsors, exhibitors, or vendors which may have a booth or table at the event, in that concessions contemplate some return in monetary remuneration or other value from the concessionaire to the granter of the concession, based at least in part upon sales or expected sales. Thus, if Verizon™ has a booth at a baseball game to market cell phones or calling cards as a result of its being a sponsor of the games, but doesn't remit any funds from sales to the stadium owner or operator, Verizon™ would not be considered a concessionaire as the term is used herein. On the other hand, the stadium owner could operate a hot dog or other concession itself. rather than having a completely independent business operate the concession.

Almost any item can serve as an event-related item. In some instances the item has a particular use related to the event, such as an entrance ticket or ticket stub, or program. The item being encapsulated could also be something that is actually used at an event, such as a baseball that is hit into the bleachers and caught by an attendee, or even a cocktail napkin or drink swirler. In still other instances an event-related item might be something purchased at the event, such as a program, a lapel pin, window sticker, or a miniature souvenir bat. An attendee might also bring an item to the event, such as a cap or other article of clothing, which gains special significance at the game, and thereby becomes an event-related item. Also contemplated are items created at the event, such as a photograph or autograph.

Of course, some event-related items are ill suited to act as mementos even when protected. In those instances it may be desirable to form a memento by combining an event-related items with some other object, so that the combination better commemorates the event than the event-related item alone would.

It is especially contemplated that the value of the encapsulated item can be enhanced by including in the container an identifier card, label, pin, logo, special graphics, or other indicia that is available only (or mostly) at the event due to contractual prohibitions on availability elsewhere. For example, a memento formed by protecting a ticket to an NHL hockey game could include a card that identifies that date, players, and location of the game, and that carries the official NHL trademark. Other contemplated indicia can comprise a trademark or service mark of the company performing the encapsulation. The currently preferred trademarks for this purpose are SECTION 1 and SECTION ONE.

The term “encapsulating” is used herein in a sense that is narrower than its broadest possible meaning. In this application we use the term “encapsulating” to mean that the item encapsulated is placed within a protective container in a manner intended to increase the perceived value of the item being encapsulated. Evidence of the intended increase in perceived value is that the owner of the object is willing to pay an additional sum to have the item encapsulated, or that the event operator is willing to pay for that service as an incentive to draw attendees to the event. Thus, according to the particular circumstances, encapsulating may or may not include laminating, inserting into a folder and sealing the folder, boxing, and slabbing.

Given this definition, the step of encapsulating an item at an event excludes ordinary packaging, bagging, and boxing because there is little or no added value. The act of putting a souvenir pen in a plastic bag is merely for convenience of carrying, and to establish the item has already been paid for. Similarly, the fact that a souvenir pen may already be packaged in a presentation case does not comprise encapsulating the pen at the event because the case was provided earlier. In any event, the seller of the pen is being paid for the pen, not for the step of encapsulating the pen.

Preferred methods of encapsulating include using a monolithic solid piece of plastic that completely envelopes the memento, or some sort of jewel case in which the memento is contained in a compartment and there is space between the memento and at least one of the inner sides walls of the compartment. Depending on the design of the case, it may or may not be possible to remove the memento without materially damaging the container or the encapsulated item. Encapsulation can, but certainly need not, involve modification of the item being encapsulated.

Encapsulation containers are preferably transparent or translucent, and can advantageously include a mat or other area that includes an official logo of the event, or perhaps a team or music group. The mat can be formed in the case itself, or can be a separate piece of card board, plastic or other material included in a compartment of the container. Contemplated services include providing the customer with a choice of mats or other designs.

As used herein, a container is “sealed” when opening of the sealed container generally results in physical damage to the seal, the container, or both. Encapsulation containers are can be sealed in any suitable manner. Some of the simplest embodiments use a latch closure, or a press closure similar to that found on some types of plastic bags. More sophisticated closures can involve sonic “welding”, locally applied heat, and using glue or other chemicals. Preferred embodiments involve closures that are difficult or impossible to open without damaging the container or contained item.

Funding for encapsulation can be provided in any suitable manner. Among other things, the service could be purchased separately from the entrance fee, included with the purchase of a ticket to the event, or included with the purchase of some other item or service. It is certainly contemplated that an attendee could pre-purchase the service, or pay when the service is provided. If pre-purchasing the service an attendee might be provided with a coupon or other token showing that the service was purchased. Alternatively, a record could be made of the purchase such that an attendee purchasing the service need only identify himself or herself in order to have the service provided.

Encapsulation performed on location at an event can benefit attendees regardless of the type of event attended. As such, attendees of sporting events, concerts, live shows, amusement parks and other attractions, movies, museums and other tourist attractions, fundraisers, ceremonies, rallies, political functions, and/or religious functions would benefit from such a service. In some instances attendance itself may comprise the event, such as when visiting historical sites, memorials and vacation spots. In other instances attendance may involve direct participation, such as when the attendee is an athlete competing in a game or other sporting event.

Encapsulation services are deemed to be performed “at an event” even if they are performed before, during, or after the main portion of the event. Thus, a stadium used for a Superbowl game, or an evening music concert, may start to fill up with attendees several hours before the game or concert actually begins. Similarly, it may take several hours after the game or concert for all of the attendees to leave the stadium. That entire time period is considered to be included for purposes of providing the encapsulating service. The same is true of a geographical area. The locale of the event would include a stadium or concert hall proper, for example, as well as related outer areas such as foyers and so forth.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic view of a method embodying the invention.

FIG. 2 is a perspective view of a memento embodying the invention.

FIG. 3 is a perspective view of a memento embodying the invention.

FIG. 4 is a perspective view of a memento embodying the invention.

FIG. 5A is a top view of a memento embodying the invention.

FIG. 5B is a front view of the memento of FIG. 5A.

FIG. 5C is a front view of the top half of the case of FIG. 5A.

FIG. 5D is a front view of the bottom half of the case of FIG. 5A.

FIG. 5E is a top view of the ID card of FIG. 5A.

FIG. 6 is a view of a wearable container that can be used to hold the memento of FIG. 5A.

FIG. 7 is a view of the container of FIG. 6 containing the memento of FIG. 5A.

### DETAILED DESCRIPTION

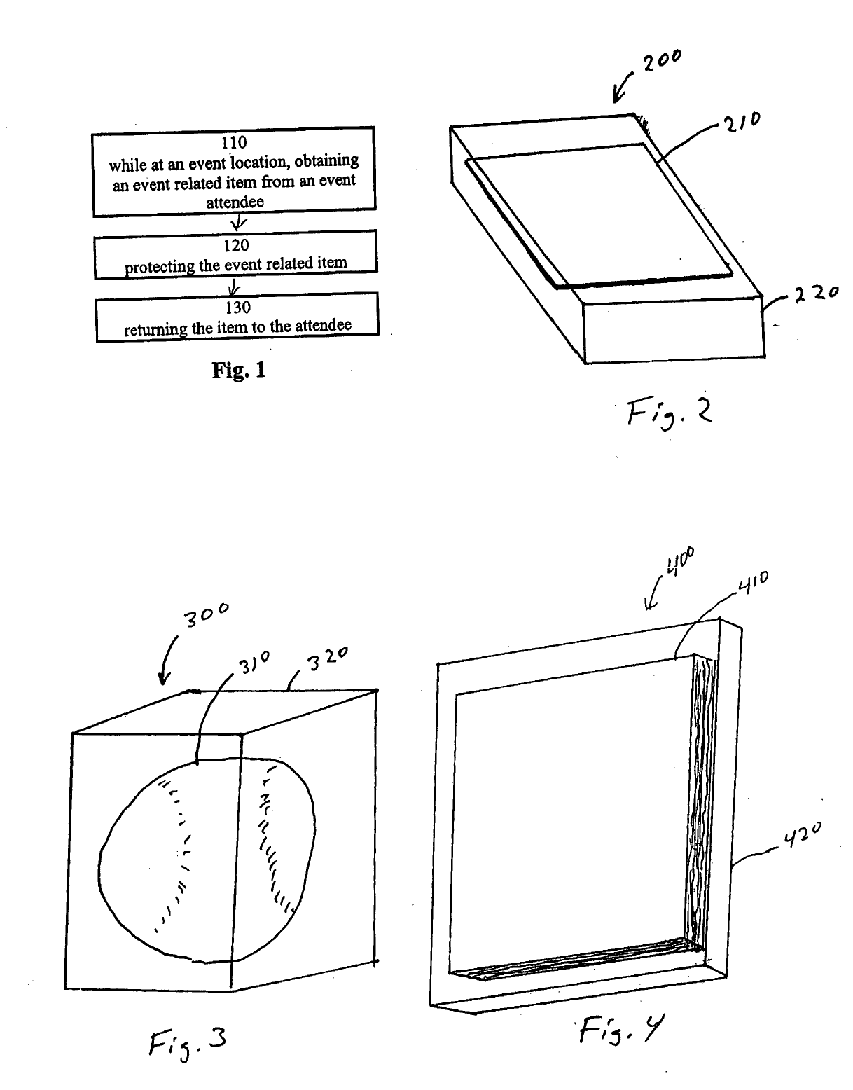

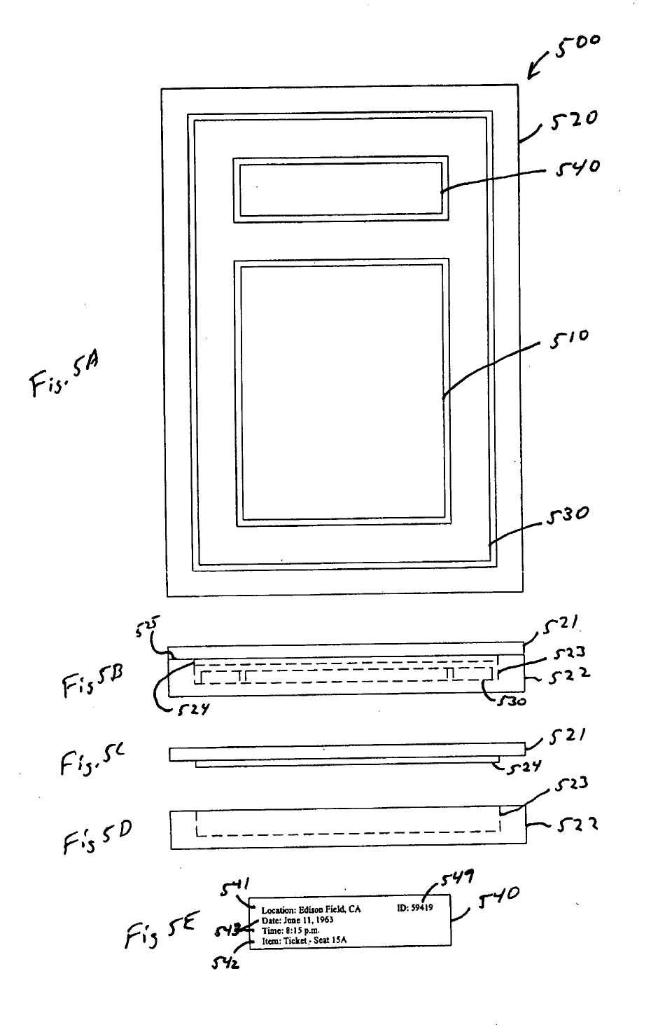

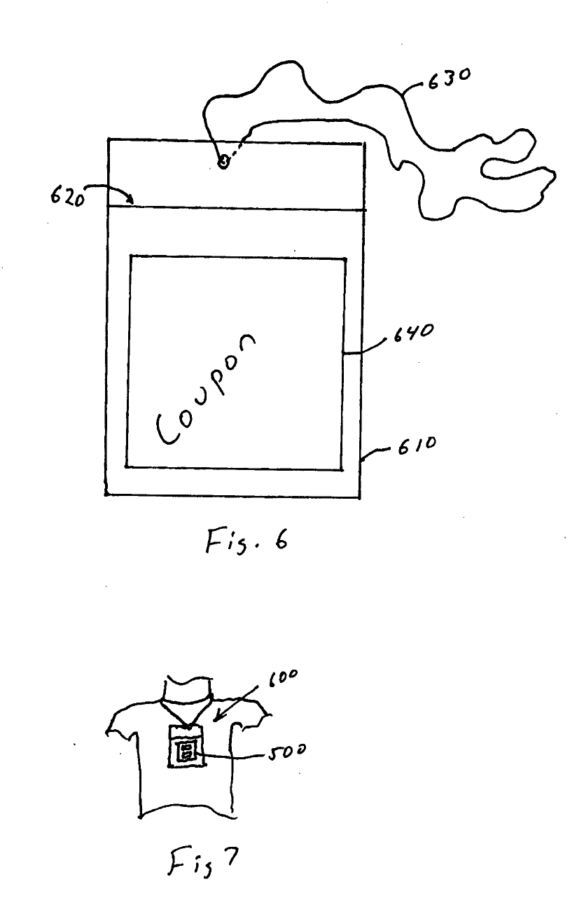

Referring to FIG. 1, a method 100 for creating a memento comprises: step 110, while at an event location, obtaining an event-related item from an event attendee; step 120, protecting the event-related item; and step 130, returning the item to the attendee. Applying such a method results in the formation of memento such as mementos 200, 300, 400, and 500 of FIGS. 2, 3, 4, and 5A. In FIG. 2, memento 200 comprises encapsulating body 220 and event-related item 210, which is a ticket used to gain access to the event at which memento 200 was formed. In FIG. 3, memento 300 comprises encapsulating body 320 and event-related item 310, which is a home run baseball caught while attending the event at which memento 300 was formed. In FIG. 4, memento 400 comprises encapsulating body 420 and event-related item 410, which is a program obtained at and describing the event at which memento 400 was formed. In FIG. 5A, memento 500 comprises encapsulating body 520 and event-related item 510, which is a ticket used to gain access to the event at which memento 500 was formed.

Method 100 is applicable regardless of the event type or location. As such, attendees of sporting events, concerts, live shows, movies, fundraisers, ceremonies, rallies, political functions, and/or religious functions would benefit from application of method 100.

As previously discussed, and as the Figures help illustrate, essentially any item can be an event-related item. Ticket 510 of FIG. 5A is an event-related item that is typically either obtained at the event or brought to the event after being obtained elsewhere, whereas baseball 310 of FIG. 3 and program 410 of FIG. 4 are typically obtained at the event, and photograph 210 of FIG. 2 is created at the event. Although an event-related item is any item that an attendee brings to, obtains, or creates at an event, it is contemplated that the method described herein is particularly well suited to forming mementos from at least one of the following event-related items, including for example, tickets, programs, game balls, and souvenirs.

Even though method 100 is at least partially performed at the location of the event that the event-related item relates to, the actual protection of the event-related item may in some instances be performed before or after the event rather than during the event. As an example, an attendee arriving at the event location early could have his or her ticket to the event protected before the event so as not to miss any of the event or risk damage to the event-related item during the event. Similarly, an attendee who obtains a game ball during the event may prefer to wait until after the event ends to have the ball protected to avoid missing the remainder of the event.

Applying method 100 at an event location immediately before, during, or immediately after an event may eliminate the need for an attendees to travel to a different location, to make an extra trip to the event location, or to lose control of the event-related item for extended periods of time by shipping it to a service provider. It is contemplated that method 100 may be advantageously applied during a time period beginning at most X hours prior to the event beginning and ending at most X hours after the event ends where X is one of 0.5, 1, 1.5, 2, 4, 8, and 24.

As previously discussed, protecting event-related items can be done in any manner that helps prevent the item from being subsequently lost or damaged. In some instances protecting the item will involve modification of the item while in other instances it will not. In preferred methods the item will be protected by encapsulation such as by encapsulating the item in a block of clear or transparent material. In still more preferred methods, encapsulation will be done in a manner that can be undone and that does not harm or change the item such as by encapsulating the item in a clear or translucent container that has a compartment adapted to contain the item without bonding to or otherwise harming the item. Besides the methods described herein, any known method for protecting items may be used such as those used to protect coins and baseball cards, so long as those methods are applied at the location of the event that the item being protected is related to.

FIG. 5A illustrates a preferred method of protection. In FIGS. 5A and 5B, a memento 500 comprises an event-related item 510 that is a ticket, a case 520, a mat 530 and an identifier card 540. Case 520 comprises separable top section 521 (also shown in FIG. 5C) and bottom section 522 (also shown in FIG. 5D), with bottom section 522 comprising cavity 523 and insert 524. Bottom section 522 and top section 521 are coupled together via sonic weld 525.

Case 520 is preferably transparent (or at least translucent) and semi-rigid to permit viewing of ticket 510 while helping to protect ticket 510 from damage. Although the case of FIG. 5A comprises two pieces, alternative embodiments may utilize a one piece case such a hinged “clam shell” type of case, or may utilize more than two pieces. Similarly, although sonic welding is a preferred method of coupling pieces together and or sealing the case shut, alternative bonding methods such as the use of fasteners and/or adhesives may be applied as well. In preferred embodiments case 520 is formed from an essentially transparent material such as polycarbonate, but less preferred embodiments may utilize other materials or combinations of materials such as glass, metals, and ceramics. It should be readily apparent that case 520 may be used to encapsulate multiple items and have a separate cavity for each item, or by having one or more cavities sized to hold multiple items such as cavity 523.

In some instances it may be advantageous to use a case/container of a particular size for a variety of different sized event-related items. In such instances the container used will comprise a cavity or other compartment larger than the item, with the item positioned within the compartment in a manner that prevents it from contacting the sides of the compartment. FIG. 5A illustrates a preferred method for positioning the item. As shown in FIG. 5A, mat 530 is placed within the cavity 523 of case 520, and ticket 510 and ID card 540 are placed within the mat such that the mat frames the item and card within the cavity. The mat is selected from a plurality of mats having differently dimensioned internal perimeters to obtain a mat that has an internal perimeter that approximates the size and shape of an external perimeter of the ticket. Thus, case 520 can be used to encapsulate a variety of different sized tickets simply by using an appropriately sized mat to effectively change the dimensions of cavity 523.

The use of a mat to effectively change the dimensions of a cavity and/or to frame an event-related item is not limited to a particular type of mat. As such mats may be paper, plastic, metal or some other material or combinations of material and may comprise a single piece or multiple pieces, and may comprise any interior and exterior shapes. As an example, if a circular token is to be protected, a plastic or metal mat having a circular interior shape and a circular, oval, or rectangular exterior shape (depending on the shape of the cavity of the encapsulating container) may be used. In some instances a mater may comprise multiple cutouts so as to position multiple items within a cavity while maintaining a desired separation between the items.

In some instances a mat may comprise text or graphics that further enhance the memento being formed. As an example, a mat used in protecting a ticket to a baseball game may include graphics reminiscent of baseball in general, the event location, and/or the teams participating in the event.

As previously discussed some event-related items are ill suited to act as mementos even when protected. As such, in some instances it may be desirable to form a memento by combining an event-related items with some other object so that the combination better commemorates the event than the event-related item alone would. Memento 500 of FIG. 5 comprises such an object in the form of ID card 540 (also shown in FIG. 5E). Card 540 may be formed from any material or combination of materials, may comprise a single piece or multiple pieces, and may have any shape and size. However, in preferred embodiments card 540 will be formed in a manner that allows text and/or graphics to be printed on it as part of the process of protecting an event-related item.

ID card 540 can include any text or graphic, including especially the event location 541, a description 542 of the item being protected, the date and time 543 when the item was protected, and an identifier 549. Alternatively or additionally, other types of information can also be included, such as information about the attending, name and address, or even a photograph of the attendee. It may be also desirable to provide confirmation that an item is related to a particular event. For memento 500, number sequence 549 provides an identifier that can be used to check the validity of an item it identifies. Although depicted as a number sequence in the example of FIG. 5A, an identifier may take any form including bar codes, letters, and other symbols. Identifier 549 can be used to access a publicly accessible (possibly via the Internet) database where the database contains a record related to memento 500 and including all or at least some of the information found on ID card 530. Such a record could be created as part of the protection process.

It is also contemplated that one or more of the text or graphics on ID card 540 can be an indicia having contractually restricted availability to the event. Thus, in the example of a NFL football game addressed above, the NFL trademark(s) would clearly have contractually restricted availability through license from the owner of the trademark(s), and their use on memorabilia containers sold by a concession at the game would preferably be limited by contact to a particular concessionaire. Indeed, it is the inherently limited nature of the restricted availability that greatly improves the value of the encapsulated products. Of course, the term “restricted availability” does not necessarily preclude some degree of availability off site, or at a later date. Thus, even if the NFL granted an exclusive license to a concessionaire to provide memento encapsulation services at its ball games, the fact that the concessionaire may provide NFL management with the service outside of a game would not defeat the limited nature of the restricted availability as those terms are employed herein.

Method 100 can be implemented as a service to attendees at an event location in a number of different ways. A service implementing method 100 could be provided free of charge, included with the purchase of a ticket to the event, included with the purchase of some other item or service, or, as is most preferred, purchased separately. Thus, it is contemplated that the attendee could pay for the encapsulating service, and alternatively some or all of the cost could be borne a sponsor or operator of the event,

As discussed, in many instances the service will most conveniently be available for purchase at events so that it can be readily obtained by event attendees. In such instances an attendee could either pre-purchase the service (possibly at a first concession stand) and subsequently obtain the service (possibly at a second concession stand removed from the first concession stand.) Alternatively, an attendee could purchase the service when the service is to be provided, so that the service is provided at or near the time of payment and without requiring much if any movement of the attendee.

If pre-purchasing the service, an attendee might be provided with a coupon or other token showing that the service was purchased. Alternatively, a record could be made of the purchase such that an attendee purchasing the service need only identify himself or herself in order to have the service provided.

In some instances an attendee may be provided with a container adapted to facilitate the attendee wearing the event-related item after it is protected, and in such a manner that the item remains visible while being worn. Such a container 600 is shown in FIG. 6, and a combination of memento 500 and container 600 being worn is shown in FIG. 7. In FIG. 6, container 600 comprises a body 610, a memento receiving pocket 620, and a coupon 630.

It is anticipated that the availability of the protection service will be advertised at the event location, at least when the service is available such as during the event. Advertising may also be done during other events, at other locations, and using any other method of advertising.

### EXAMPLE #1

A service provider obtains permission from the appropriate parties to provide memorabilia services at the Edison Field ballpark. Prior to the start of a baseball game played at the ballpark, the service provider arranges to have advertisements of its service placed in strategic locations throughout the ballpark, and in newspapers, radio commercials and television commercials. The service provider also arranges to have a concession stand set up or made available to him, and subsequently sets up any tables, racks, displays, sonic welders, and/or any other equipment that may be necessary to provide its services. A few hours prior to the baseball game beginning, the service provider mans its concession stand and begins to accept payment for its services as well as event-related items such as tickets. After receiving payment and the item, the service provider prints an ID card, possibly selects a mat appropriate for framing the item, and then encapsulates the event-related item, ID card, and possibly the mat in a transparent or translucent container and seals the container shut by sonically welding its pieces together.

### EXAMPLE #2

A service provider takes the same steps as in Example #1, but arranges to have multiple concession stands set up or made available to him and subsequently sets up the concession stands with at least one stand being dedicated to the sale of the service and/or at least one stand being dedicated to encapsulating event-related items. After purchasing the service at a first stand an attendee is provided with a wearable container containing a coupon evidencing payment. At some later time the attendee takes the coupon and container to a second concession stand, provides an event-related item to the service provider, and exchanges the coupon for protection of the event-related item. After having the event-related item protected the attendee places the item in the wearable container and wears the combination for the remainder of the event.

### EXAMPLE #3

An attendee at a baseball game purchases a packet from a seller walking the stands, hallways, and boxes of the stadium. The packet includes all the encapsulation materials, some of which may be preprinted with game identifying information, as well as an authorization for a sealing service. Sometime before, during, or after the game, the holder carries the packet and his ticket to one of several concessionaire booths, and an attendee at the booth uses a sonic or other machine to seal or otherwise encapsulate the ticket inside the encapsulation container.

Thus, mementos and methods for creating such mementos on site at an event location have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components or steps that are not expressly referenced.

1. A method of creating a memento at an event location, comprising:
providing a concession service at the location to encapsulate event-related items;
obtaining an event-related item from an event attendee;
encapsulating the event-related item in a container; and
then delivering the container to the attendee.

2. The method of claim 1 wherein the event-related item includes information specific to the event.

3. The method of claim 1 wherein the item comprises at least a portion of a ticket to the event.

4. The method of claim 1 wherein the step of encapsulating includes sealing the container.

5. The method of claim 1 wherein the step of encapsulating includes matting the item in the container.

6. The method of claim 1 further comprising adding to the container an indicia having contractually restricted availability to the event.

7. The method of claim 1 further comprising adding to the container information that can be used to access a record in a publicly accessible database.

8. The method of claim 1 further comprising obtaining payment from the attendee for the service.

9. The method of claim 1 further comprising providing the attendee with a device that facilitates wearing of the container by the attendee.

10. An encapsulated memento comprising:
an event-related item;
an indicia having contractually restricted availability to the event; and
a container that encapsulates the item and includes the indicia.

11. The memento of claim 10 wherein the event-related item comprises at least a portion of at least one of a ticket, an event program, a cocktail napkin, a drink swirler, a lapel pin, a window sticker, a souvenir, a photograph, and an autograph.

12. The memento of claim 10 wherein the indicia indicates at least one of a date, location, team, and performer of/at the event.

13. The memento of claim 10 wherein the indicia includes a trademark associated with an owner or sponsor of the event.

14. The memento of claim 10 wherein the indicia includes a trademark associated with a facility in which the event takes place.

15. The memento of claim 10 wherein the indicia includes a trademark associated with a concessionaire that provides a service of encapsulating the item at the event.

16. The memento of claim 10 wherein:
the indicia indicates at least one of a date, location, team, and performer of/at the event;
the indicia further includes at least one of a trademark associated with an owner or sponsor of the event, and a trademark associated with a facility in which the event takes place; and
the indicia further includes a trademark associated with a concessionaire that provides a service of encapsulating the item at the event.

17. The memento of claim 10 wherein the container is sealed.

18. The memento of claim 10 wherein the container comprises transparent or translucent rigid plastic.

19. The method of claim 10 wherein the container includes a mat.

20. A method of protecting an event-related item, comprising paying a service provider at an event to enclose the item in a container.

21. The method of claim 20 further comprising the service provider adding to the container at least one of a date, location, team, and performer of/at the event.

22. The method of claim 21 further comprising the service provider adding to the container at least one of a trademark associated with an owner or sponsor of the event, and a trademark associated with a facility in which the event takes place; and

23. The method of claim 21 further comprising the service provider adding to the container a trademark associated with a concessionaire that provides a service of encapsulating the item at the event.

24. The method of claim 21 wherein the step of paying the service provider comprises an attendee of the event effecting payment.

25. The method of claim 21 wherein the step of paying the service provider comprises a sponsor or operator of the event, or a participant in the event, effecting payment.
